(19) United States
(12) Patent Application Publication
(10) Pub. No.: US 2026/0257746 A1
(43) Pub. Date: Sep. 3, 2026

(54) BICYCLE FRAME

(71) Applicant: Ninebot (Shenzhen) Tech Co., Ltd., Shenzhen (CN)

(72) Inventor: Yubao XIE, Shenzhen (CN)

(21) Appl. No.: 19/459,415

(22) Filed: Jan. 26, 2026

(30) Foreign Application Priority Data
Mar. 3, 2025 (CN) 202520358006.X

(51) Int. Cl. B62K 3/02

(52) U.S. Cl. CPC B62K 3/02

(57) ABSTRACT

A bicycle frame includes a frame tube and a wire pressing piece; a tube cavity of the frame tube is configured for a wire to pass through, and at least part of the wire is located within the tube cavity of the frame tube; the wire pressing piece is arranged within the tube cavity of the frame tube, two ends of the wire pressing piece are connected to an inner wall of the frame tube, the at least part of the wire abuts between a target wall of the frame tube and the wire pressing piece, the wire pressing piece is provided with a wire-passing opening configured for passage of the at least part of the wire, and the wire-passing opening disconnects the wire pressing piece between the two ends of the wire pressing piece.

### CROSS-REFERENCE TO RELATED APPLICATION

The present disclosure is based on and claims priority to Chinese Patent Application No. 202520358006.X, filed on March 03, 2025, the entire content of which is incorporated into the present invention by reference.

### FIELD

The present disclosure relates to the technical field of frames of a bicycle, and in particular to a bicycle frame.

### BACKGROUND

With continuous development of a frame of bicycle in related arts, a bicycle frame come in a variety of types and are applied in diverse scenarios, such as a front triangle frame applied to electric bicycles.

A current bicycle frame includes a tube body. A partition plate parallel to the length direction of the tube body is fixedly connected inside the tube body. The partition plate divides a inner cavity of the tube body into two cavities, and a target cavity of the two cavities is used for routing. During the assembly of the bicycle frame, one end of a wire (e.g., a motor wire) may be inserted into the target cavity from a first end of the bicycle frame and then passed out of the target cavity from a second end of the bicycle frame, so that part of the wire is located inside the target cavity. Subsequently, the wire is fixed relative to the bicycle frame by means of a connecting structure such as a buckle, a sheet metal part and/or a screw. Thus, when the bicycle assembled on the basis of the bicycle frame is in use, the position of the wire inside the bicycle frame relative to the bicycle frame is relatively stable.

However, fixing the wire relative to the bicycle frame is achieved by installing connecting structures like the buckle, the sheet metal part and/or the screw. This fixing method is rather cumbersome, resulting in low efficiency in fixing the wire relative to the bicycle frame.

### SUMMARY

In view of this, embodiments of the present disclosure provide a bicycle frame to at least partially solve the aforementioned problems.

A bicycle frame provided according to embodiments of the present disclosure includes a frame tube and a wire pressing piece; wherein the frame tube has a tube cavity configured for a wire to pass through and configured to accommodate at least part of the wire; wherein the wire pressing piece is arranged within the tube cavity of the frame tube, two ends of the wire pressing piece are connected to an inner wall of the frame tube, a space between the wire pressing piece and a target wall of the frame tube is configured to accommodate the at least part of the wire , the wire pressing piece is provided with a wire-passing opening configured for passage of the at least part of the wire, and the wire-passing opening disconnects the wire pressing piece between the two ends of the wire pressing piece; and wherein, the target wall is a part of a tube wall of the frame tube located at a side of the wire pressing piece.

The bicycle frame provided according to embodiments of the present disclosure includes the frame tube and the wire pressing piece arranged within the tube cavity of the frame tube, and the wire pressing piece is provided with a wire-passing opening. Thus, since the wire-passing opening disconnects the wire pressing piece between the two ends of the wire pressing piece, during the assembly process based on the bicycle frame, the wire may first be passed through the frame tube so that at least part of the wire is located within the tube cavity of the frame tube, and then the at least part of the wire is directly inserted between the wire pressing piece and the target wall of the frame tube through the wire-passing opening at the wire pressing piece. Thus, the wire may be fixed relative to the frame tube, thereby realizing the fixation of the wire relative to the bicycle frame. This fixing method is simple and efficient, which improves the efficiency of fixing the wire relative to the bicycle frame.

### BRIEF DESCRIPTION OF THE DRAWINGS

To more clearly illustrate the technical solution in embodiments of the present disclosure or the related art, the accompanying drawings required for describing embodiments or the related art will be briefly introduced below. Apparently, the accompanying drawings in the following description are merely some embodiments recorded in the present disclosure. Those of ordinary skill in the art may also obtain other drawings based on these accompanying drawings.

FIG. 1 is a schematic structural view of a bicycle frame according to an embodiment of the present disclosure;

FIG. 2 is a schematic structural view highlighting a frame tube according to an embodiment of the present disclosure;

FIG. 3 is a schematic structural view highlighting an operation opening according to an embodiment of the present disclosure.

### DETAILED DESCRIPTION

To clarify the objectives, technical solutions and advantages of the present disclosure, the implementations of the present disclosure will be described in further detail below with reference to the accompanying drawings.

In the description of the present disclosure, it should be understood that the terms "center", "upper", "lower", "front", "rear", "left", "right", "vertical", "horizontal", "top", "bottom", "inner", "outer" and the like indicating orientations or positional relationships are based on the orientations or positional relationships shown in the accompanying drawings, which are only for the convenience of describing the present disclosure and simplifying the description, rather than indicating or implying that the referred device or element must have a specific orientation, be constructed and operated in a specific orientation. Therefore, such terms shall not be construed as limiting the present disclosure.

A bicycle frame provided by embodiments of the present disclosure will be described in detail below with reference to the accompanying drawings.

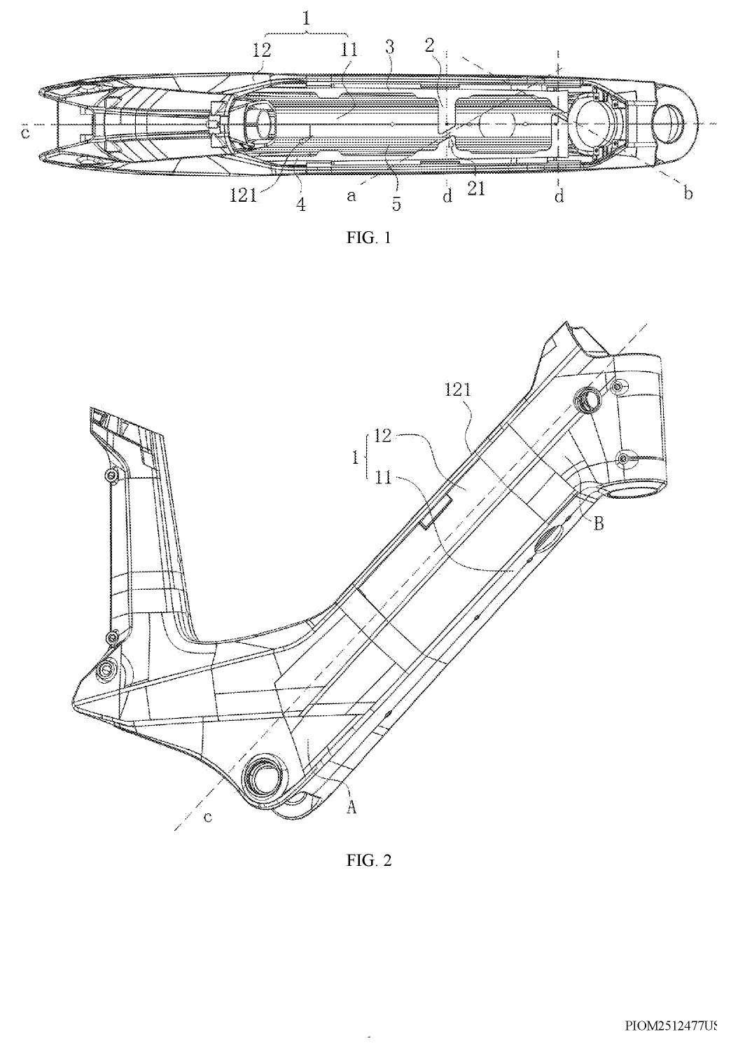

FIGS. 1 and 2 are schematic structural views of a bicycle frame according to an embodiment of the present disclosure. As shown in FIGS. 1 and 2, the bicycle frame includes a frame tube 1 and a wire pressing piece 2; a tube cavity of the frame tube 1 is configured for a wire 5 (or wires 5) to pass through, and at least part of the wire 5 is located within the tube cavity of the frame tube 1; the wire pressing piece 2 is arranged within the tube cavity of the frame tube 1, two ends of the wire pressing piece 2 are connected to an inner wall of the frame tube 1; a space between the wire pressing piece 2 and a target wall 11 of the frame tube 1 is configured to accommodate the at least part of the wire 5, that is., the aforementioned at least part of the wire 5 abuts between the target wall 11 of the frame tube 1 and the wire pressing piece 2; the wire pressing piece 2 is provided with a wire-passing opening 21 configured for passage of the aforementioned at least part of the wire 5, and the wire-passing opening 21 disconnects the wire pressing piece 2 between the two ends of the wire pressing piece 2, and the target wall 11 refers to a part of the inner wall of the frame tube 1 located at a side of the wire pressing piece 2.

The bicycle frame may be at least part of the frame of a bicycle (which may be an electric bicycle, a non-electric bicycle, etc.), and the bicycle frame is configured for connecting with the wire 5 included in the bicycle. For example, the bicycle frame may be a front triangle frame applied to an electric bicycle or a non-electric bicycle, and the specific type of the bicycle frame is not limited in embodiments of the present disclosure; the wire 5 is a wire installed on the bicycle frame, such as a motor wire or a brake wire, and the specific type of the wire 5 is not limited in embodiments of the present disclosure. It should be noted that if the wire 5 is a motor wire, the bicycle frame is at least part of the frame of an electric bicycle.

During the assembly process based on the bicycle frame, the first end of the wire 5 may be inserted into the tube cavity of the frame tube 1 from the first end (e.g., end A in FIG. 2) of the frame tube 1 and then passed out from the second end (e.g., end B in FIG. 2) of the frame tube 1 (alternatively, the first end of the wire 5 may be inserted into the tube cavity of the frame tube 1 from the second end of the frame tube 1 and then passed out from the first end of the frame tube 1, which is not limited in embodiments of the present disclosure; the present description takes "inserting the first end of the wire 5 into the tube cavity of the frame tube 1 from the first end of the frame tube 1 and then passing it out from the second end of the frame tube 1" as an example for description). At this time, both the first end and the second end of the wire 5 are located outside the frame tube 1, and the part of the wire 5 to be installed in the tube cavity of the frame tube 1 (i.e., the aforementioned at least part of the wire 5) is located within the tube cavity of the frame tube 1. Then, since the wire-passing opening 21 disconnects the wire pressing piece 2 between the two ends of the wire pressing piece 2, the aforementioned at least part of the wire 5 may be directly inserted between the wire pressing piece 2 and the target wall 11 of the frame tube 1 through the wire-passing opening 21 on the wire pressing piece 2, so that the aforementioned at least part of the wire 5 abuts between the target wall 11 of the frame tube 1 and the wire pressing piece 2. At this point, the wire 5 is fixed relative to the frame tube 1, thereby achieving the fixation of the wire 5 relative to the bicycle frame.

In embodiments of the present disclosure, the bicycle frame includes the frame tube 1 and the wire pressing piece 2 arranged within the tube cavity of the frame tube 1, and the wire pressing piece 2 is provided with the wire-passing opening 21. Thus, since the wire-passing opening 21 disconnects the wire pressing piece 2 between the two ends of the wire pressing piece 2, during the assembly process based on the bicycle frame, the wire 5 may first be passed through the frame tube 1 so that at least part of the wire 5 is located within the tube cavity of the frame tube 1, and then the at least part of the wire 5 is directly inserted between the wire pressing piece 2 and the target wall 11 of the frame tube 1 through the wire-passing opening 21 on the wire pressing piece 2. At this point, the wire 5 may be fixed relative to the frame tube 1, thereby realizing the fixation of the wire 5 relative to the bicycle frame. This fixing method is simple and efficient, which improves the efficiency of fixing the wire 5 relative to the bicycle frame.

In addition, the wire pressing piece 2 in the present disclosure makes the bicycle frame compact in structure, eliminating the need for additional parts to fix the wire 5, and features high safety and reliability, excellent wire fixing effect, simple structure and cost saving.

In some embodiments, as shown in FIG. 1, the first end and the second end of the wire 5 pass through the frame tube 1 and are connected to other components of the bicycle outside the frame tube 1. For example, if the wire 5 is a motor wire, the first end of the wire 5 may be connected to a motor, and the second end of the wire 5 may be connected to a controller, which is not limited in the present disclosure.

In some embodiments, the frame tube 1 may be at least part of the tube body in the bicycle frame. For example, as shown in FIG. 1, the frame tube 1 is a part of the tube body of the bicycle frame, the first end of the frame tube 1 is communicated with other tube bodies of the bicycle frame, and the second end of the frame tube 1 is used for connecting with the bicycle handlebar.

In a possible implementation, as shown in FIG. 1, the length direction of the wire-passing opening 21 is not parallel to the length direction of the frame tube 1, wherein the length direction of the wire-passing opening refers to the direction from the first end to the second end of the wire-passing opening, the first end of the wire-passing opening is the end of the wire-passing opening adjacent to the first end of the frame tube, and the second end of the wire-passing opening is the end of the wire-passing opening adjacent to the second end of the frame tube.

For example, the length direction of the wire-passing opening 21 of one wire pressing piece 2 in FIG. 1 (see dashed line a in FIG. 1) is not parallel to the length direction of the frame tube 1 (see dashed line c in FIGS. 1 and 2), and the length direction of the wire-passing opening 21 of another wire pressing piece 2 in FIG. 1 (see dashed line b in FIG. 1) is also not parallel to the length direction of the frame tube 1.

Thus, since the length direction of the wire 5 abutting between the wire pressing piece 2 and the target wall 11 of the frame tube 1 is basically parallel to the length direction of the frame tube 1, the non-parallelism between the length direction of the wire-passing opening 21 and the length direction of the frame tube 1 means that the length direction of the wire-passing opening 21 is not parallel to the length direction of the wire 5, which may reduce the possibility of the wire 5 abutting between the wire pressing piece 2 and the target wall 11 of the frame tube 1 slipping out, and improve the positional stability of the wire 5 relative to the frame tube 1.

In some embodiments, the width of the wire-passing opening 21 is greater than or equal to the diameter of the wire 5 to facilitate the passage of the wire 5 through the wire-passing opening 21.

In a possible implementation, as shown in FIG. 1, a plurality of wire pressing pieces 2 (two wire pressing pieces 2 are taken as an example in the accompanying drawings) are arranged along the length direction of the frame tube 1; and the length directions of the wire-passing openings 21 on at least part of the different wire pressing pieces 2 of the plurality of wire pressing pieces 2 are not collinear.

For example, the length direction of the wire-passing opening 21 of one wire pressing piece 2 in FIG. 1 (see dashed line a in FIG. 1) is not collinear with the length direction of the wire-passing opening 21 of the another wire pressing piece 2 in FIG. 1 (see dashed line b in FIG. 1).

Thus, the non-collinearity of the length directions of the wire-passing openings 21 on at least part of the different wire pressing pieces 2 may reduce the possibility of the wire 5 abutting between the wire pressing piece 2 and the target wall 11 of the frame tube 1 slipping out, and improve the positional stability of the wire 5 relative to the frame tube 1.

In a possible implementation, as shown in FIG. 1, the wire pressing piece 2 is a sheet-shaped piece. Thus, the sheet-shaped wire pressing piece 2 occupies less space in the frame tube 1, which may provide a larger installation space for other components (e.g., the battery of an electric bicycle) to be installed in the frame tube 1.

In a possible implementation, as shown in FIG. 1, the first end of the wire pressing piece 2 connected to the inner wall of the frame tube 1 is an end of the wire pressing piece 2 along the length direction of the wire pressing piece 2, and the second end of the wire pressing piece 2 connected to the inner wall of the frame tube 1 is another end of the wire pressing piece 2 along the length direction of the wire pressing piece 2.

Thus, the technical solution in the present disclosure where both ends of the wire pressing piece 2 along the length direction of the wire pressing piece 2 are connected to the inner wall of the frame tube 1 enables more wires 5 to abut between the wire pressing piece 2 and the target wall 11 of the frame tube 1, and also realizes the fixation of more wires 5 with a smaller wire pressing piece 2.

In a possible implementation, as shown in FIG. 1, a first connecting strip 3 and a second connecting strip 4 are arranged on the inner wall of the frame tube 1; the length directions of both the first connecting strip 3 and the second connecting strip 4 are parallel to the length direction of the frame tube 1, the first end of the wire pressing piece 2 is connected to the first connecting strip 3, and the second end of the wire pressing piece 2 is connected to the second connecting strip 4.

Thus, the arrangement of the first connecting strip 3 and the second connecting strip 4 may reinforce the connection between the ends of the wire pressing piece 2 and the inner wall of the frame tube 1.

In some embodiments, both the first connecting strip 3 and the second connecting strip 4 may be integrally connected or fixedly connected to the frame tube 1, and the first end of the wire pressing piece 2 may be integrally connected or fixedly connected to the first connecting strip 3, and the second end of the wire pressing piece 2 may be integrally connected or fixedly connected to the second connecting strip 4.

For example, the frame tube 1, the first connecting strip 3, the second connecting strip 4 and the wire pressing piece 2 may be integrally formed, and the shape is controlled by a sand core, so that both the first connecting strip 3 and the second connecting strip 4 are integrally connected to the inner wall of the frame tube 1, the first end of the wire pressing piece 2 is integrally connected to the first connecting strip 3, and the second end of the wire pressing piece 2 is integrally connected to the second connecting strip 4. Thus, the integral forming of the frame tube 1, the first connecting strip 3, the second connecting strip 4 and the wire pressing piece 2 may be completed without using Computer Numerical Control (CNC), which saves processing man-hours and costs, and also reduces the weight of the frame itself.

In a possible implementation, as shown in FIG. 1, the included angle between the length direction of the wire pressing piece 2 (see dashed line d in FIG. 1) and the length direction of the frame tube 1 (see dashed line c in FIG. 1) is greater than or equal to 45 degrees and less than or equal to 90 degrees. Thus, while ensuring that the wire pressing piece 2 may stably abut and fix the wire 5 in the frame tube 1, the length of the wire pressing piece 2 may be minimized to save materials and reduce costs. On this basis, an included angle of 90 degrees between the length direction of the wire pressing piece 2 and the length direction of the frame tube 1 is the most preferred, which may achieve maximum material saving and cost reduction.

In a possible implementation, as shown in FIG. 1, the thickness of the wire pressing piece 2 is greater than or equal to 3.5 millimeters, and the width of the wire pressing piece 2 is greater than or equal to 6 millimeters, which thus not only saves materials but also reduces the possibility of the wire pressing piece 2 being squeezed and deformed or even damaged.

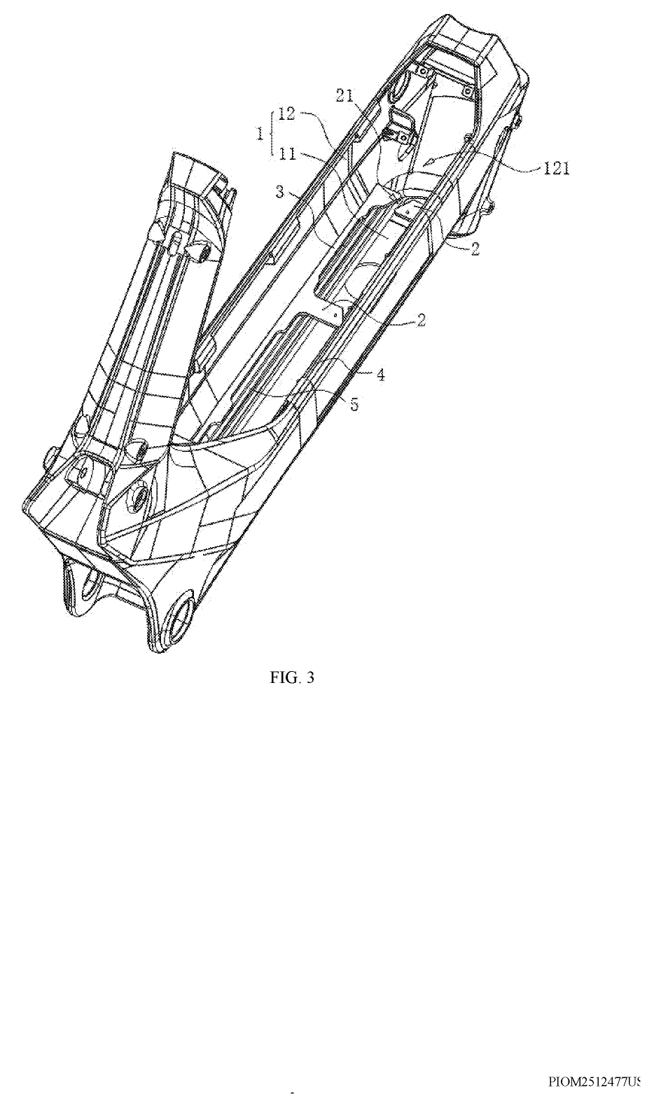

In a possible implementation, as shown in FIG. 3, a through operation opening 121 is formed in the non-target wall 12 of the frame tube 1, wherein the non-target wall 12 refers to the part of the tube wall of the frame tube 1 located at the side of the wire pressing piece 2 facing away from the target wall 11.

During the assembly process based on the bicycle frame, the first end of the wire 5 may be inserted into the part between the non-target wall 12 and the wire pressing piece 2 in the tube cavity of the frame tube 1 from the first end of the frame tube 1 and then passed out from the second end of the frame tube 1. At this time, both the first end and the second end of the wire 5 are located outside the frame tube 1, and the part of the wire 5 to be installed in the tube cavity of the frame tube 1 (i.e., the aforementioned at least part of the wire 5) is located in the part between the non-target wall 12 and the wire pressing piece 2 in the tube cavity of the frame tube 1. Then, the aforementioned at least part of the wire 5 may be directly inserted between the wire pressing piece 2 and the target wall 11 of the frame tube 1 through the wire-passing opening 21 of the wire pressing piece 2 via the operation opening 121, so that the aforementioned at least part of the wire 5 abuts between the target wall 11 of the frame tube 1 and the wire pressing piece 2. Subsequently, other components to be installed in the frame tube 1 (e.g., the battery of an electric bicycle) may be installed between the wire pressing piece 2 and the non-target wall 12 of the frame tube 1 through the operation opening 121, so that the other components are installed in the frame tube 1. Thus, the provision of the operation opening 121 facilitates the assembly based on the bicycle frame.

In some embodiments, as shown in FIG. 1, in the tube cavity of the frame tube 1, the space between the non-target wall 12 and the wire pressing piece 2 is larger than the space between the target wall 11 and the wire pressing piece 2, which facilitates the passage of the connector of the wire 5 through the tube cavity of the frame tube 1 during the assembly based on the bicycle frame.

In some embodiments, as shown in FIG. 1, a cover plate (not shown in the figure) for covering the operation opening 121 may be arranged at the operation opening 121. The cover plate may be detachably connected or fixedly connected to the frame tube 1, which is not limited in embodiments of the present disclosure.

In a possible implementation, as shown in FIG. 1, a partition plate (not shown in the figure) is further arranged in the tube cavity of the frame tube 1; the partition plate may be made of plastic or other materials, and the material of the partition plate is not limited in embodiments of the present disclosure; the wire pressing piece 2 is located between the partition plate and the wire 5, and the side surface of the partition plate adjacent to the wire pressing piece 2 is connected to the wire pressing piece 2. For example, the side of the wire pressing piece 2 away from the wire 5 is bonded to the partition plate by self-adhesive attached to the side surface of the partition plate adjacent to the wire pressing piece 2.

Thus, the partition plate may cover the wire pressing piece 2, the wire 5 and other components in the tube cavity of the frame tube 1, improving the aesthetics of the interior of the tube cavity of the frame tube 1.

It should be noted that in the present disclosure, relational terms such as "first" and "second" are only used to distinguish one entity or operation from another entity or operation, and do not necessarily require or imply that there is any actual relationship or order between these entities or operations. Furthermore, the terms "comprise", "include" or any other variants thereof are intended to cover non-exclusive inclusion, so that a process, method, article or device including a series of elements not only includes those elements but also includes other elements not explicitly listed, or elements inherent to such a process, method, article or device. Without further limitations, an element defined by the phrase "comprising a/an..." does not exclude the presence of other identical elements in the process, method, article or device that comprises the element.

Finally, it should be noted that the above are only preferred embodiments of the present invention and are only used to illustrate the technical solutions of the present invention, but not to limit the protection scope of the present invention. Any modification, equivalent replacement, improvement, etc. made within the spirit and principle of the present invention shall be included in the protection scope of the present invention.

1. A bicycle frame, comprising: a frame tube and a wire pressing piece;
wherein the frame tube has a tube cavity configured for a wire to pass through and configured to accommodate at least part of the wire;
wherein the wire pressing piece is arranged within the tube cavity of the frame tube, two ends of the wire pressing piece are connected to an inner wall of the frame tube, a space between the wire pressing piece and a target wall of the frame tube is configured to accommodate the at least part of the wire , the wire pressing piece is provided with a wire-passing opening configured for passage of the at least part of the wire, and the wire-passing opening disconnects the wire pressing piece between the two ends of the wire pressing piece; and
wherein the target wall is a part of a tube wall of the frame tube located at a side of the wire pressing piece.

2. The bicycle frame according to claim 1, wherein a length direction of the wire-passing opening is not parallel to a length direction of the frame tube; and
wherein the length direction of the wire-passing opening refers to a direction from a first end of the wire-passing opening to a second end of the wire-passing opening, the first end of the wire-passing opening is an end of the wire-passing opening adjacent to a first end of the frame tube, and the second end of the wire-passing opening is an end of the wire-passing opening adjacent to a second end of the frame tube.

3. The bicycle frame according to claim 2, wherein a plurality of the wire pressing pieces are arranged along the length direction of the frame tube; and
wherein length directions of the wire-passing openings of at least part of different wire pressing pieces of the plurality of the wire pressing pieces are not collinear.

4. The bicycle frame according to claim 1, wherein the wire pressing piece is a sheet-shaped piece.

5. The bicycle frame according to claim 4, wherein a first end of the wire pressing piece connected to the inner wall of the frame tube is an end of the wire pressing piece along a length direction of the wire pressing piece; and a second end of the wire pressing piece connected to the inner wall of the frame tube is another end of the wire pressing piece along the length direction of the wire pressing piece.

6. The bicycle frame according to claim 5, wherein a first connecting strip and a second connecting strip are arranged on the inner wall of the frame tube; and
length directions of the first connecting strip and the second connecting strip are both parallel to a length direction of the frame tube; the first end of the wire pressing piece is connected to the first connecting strip, and the second end of the wire pressing piece is connected to the second connecting strip.

7. The bicycle frame according to claim 5, wherein an included angle between the length direction of the wire pressing piece and a length direction of the frame tube is greater than or equal to 45 degrees and less than or equal to 90 degrees.

8. The bicycle frame according to claim 4, wherein a thickness of the wire pressing piece is greater than or equal to 3.5 millimeters; and a width of the wire pressing piece is greater than or equal to 6 millimeters.

9. The bicycle frame according to claim 1, wherein a through operation opening is formed in a non-target wall of the frame tube; and the non-target wall is a part of the tube wall of the frame tube located at a side of the wire pressing piece facing away from the target wall.

10. The bicycle frame according to claim 1, wherein a partition plate is further arranged in the tube cavity of the frame tube; the wire pressing piece is configured to be located between the partition plate and the wire; and a side surface of the partition plate adjacent to the wire pressing piece is connected to the wire pressing piece.
